(19) United States
(12) Patent Application Publication
(10) Pub. No.: US 2018/0068074 A1
(43) Pub. Date: Mar. 8, 2018

(54) METHOD, APPARATUS AND SYSTEM OF GENERATING ELECTRONIC MEDICAL RECORD INFORMATION

(71) Applicant: BOE TECHNOLOGY GROUP CO., LTD., Beijing (CN)

(72) Inventor: Chenyin SHEN, Beijing (CN)

(21) Appl. No.: 15/685,014

(22) Filed: Aug. 24, 2017

(30) Foreign Application Priority Data
Sep. 5, 2016 (CN) 201610804139.0

(51) Int. Cl. G06F 19/00; G06F 17/27; G10L 15/18; G10L 15/22

(52) U.S. Cl. CPC G06F 19/322; G06F 19/321; G10L 15/22; G10L 15/1815; G06F 17/2785

(57) ABSTRACT

An embodiment of the present disclosure provides a method and apparatus of generating electronic medical record information, which relates to the field of digital medical technology. The method includes: retrieving a corpus of a target object from a pre-stored database; acquiring voice information of a conversation during a consultation of a user, the voice information comprising at least one of real-time voice information and recorded voice information; performing voice recognition on the voice information according to the corpus, to obtain a voice recognition result; and performing semantic analysis on the voice recognition result, and generating object state information of the target object in an electronic medical record.

### CROSS-REFERENCES TO RELATED APPLICATIONS

This application claims priority to Chinese Patent Application No. 201610804139.0 filed in China on Sep. 5, 2016, the entire contents of which are hereby incorporated by reference.

### TECHNICAL FIELD

The present disclosure relates to the field of digital medical technology, and more particularly to a method and an apparatus of generating electronic medical record information.

### BACKGROUND

With the popularity of medical electronic informatization, an electronic medical record has become an essential manner to record medical information in hospitals.

In an existing electronic medical record generating scheme, a doctor is required to activate electronic medical record programs installed in a computer. Then in a consultation process, the doctor manually enters a content of a medical record by using a template of an electronic medical record, and stores it as an electronic medical record for a patient.

It should be noted that, information disclosed in the above background portion is provided only for better understanding of the background of the present disclosure, and thus it may contain information that does not form the prior art known by those ordinary skilled in the art.

### SUMMARY

Embodiments of the present disclosure provide a method, an apparatus and a system of generating electronic medical record information.

In order to achieve the above object, the embodiments of the present disclosure employ the following technical scheme.

In one aspect, an embodiment of the present disclosure provides a method of generating electronic medical record information, including: retrieving a corpus of a target object from a pre-stored database; acquiring voice information of a conversation during a consultation of a user, the voice information including at least one of real-time voice information and recorded voice information; performing voice recognition on the voice information according to the corpus, to obtain a voice recognition result; and performing semantic analysis on the voice recognition result, and generating object state information of the target object in an electronic medical record.

In another aspect, an embodiment of the present disclosure provides an apparatus for generating an electronic medical record, including: a processor; and a memory, configured to store instructions executable by the processor, wherein the processor is configured to: retrieve a corpus of a target object; acquire voice information of a conversation during a consultation of a user, the voice information including at least one of real-time voice information and recorded voice information; perform voice recognition on the voice information according to the corpus, to obtain a voice recognition result; and perform semantic analysis on the voice recognition result, and generate object state information of the target object in an electronic medical record.

In a further aspect, an embodiment of the present disclosure provides a system for generating an electronic medical record, including: the above apparatus for generating an electronic medical record; and a database that is in data connection to the apparatus for generating an electronic medical record, the database storing at least one of the corpus and an image library of the target object.

It is to be understood that both the foregoing general description and the following detailed description are exemplary and explanatory only and are not restrictive of the present disclosure, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

FIG. 1 is an architectural schematic diagram of a system of generating electronic medical record information provided by an embodiment of the present disclosure;

FIG. 2 is a first flow chart of a method of generating electronic medical record information provided by an embodiment of the present disclosure;

FIG. 3 is a second flow chart of a method of generating electronic medical record information provided by an embodiment of the present disclosure;

FIG. 4 is a user interface of a generating apparatus provided by an embodiment of the present disclosure;

FIG. 5 is a first structural schematic diagram of a generating apparatus provided by an embodiment of the present disclosure;

FIG. 6 is a second structural schematic diagram of a generating apparatus provided by an embodiment of the present disclosure;

FIG. 7 is a third structural schematic diagram of a generating apparatus provided by an embodiment of the present disclosure; and

FIG. 8 is a structural schematic diagram of a computer device provided by an embodiment of the present disclosure.

### DETAILED DESCRIPTION

The technical schemes in the embodiments of the present disclosure will be described clearly and completely below in conjunction with the accompanying drawings in the embodiment of the present disclosure. It is apparent that the described embodiments are merely part of the embodiments rather than all of the embodiments of the present disclosure.

In addition, the terms “first” and “second” are only for illustrative purposes and are not to be construed as indicating or implying relative importance or implicitly designating the number of technical features indicated. Thus, features defined by “first” or “second” may expressly or implicitly include one or more of the features. In the description of the present disclosure, the meaning of “a plurality” of is two or more, unless otherwise specified.

The embodiment of the present disclosure provides a method of generating electronic medical record information, which may be applied to a system 100 for generating an electronic medical record as shown in FIG. 1. The system 100 includes an apparatus for generating an electronic medical record 01 (simply referred to as a generating apparatus in following embodiments), and a database 02 that is in data connection to the generating apparatus 01. At least one of a corpus and an image library of a target object is stored in the database 02.

In the embodiment, the corpus refers to: a large-scale electronic text library obtained by scientific sampling and processing. With the help of computer analysis tools, users may carry out relevant language theories and application researches.

Specifically, the corpus may store a plurality of pairs of corpus samples. Each pair of corpus samples includes original voice information and a correct electronic text corresponding to the original voice information. For example, voice information of “I am an Olympic champion” may be used as the original voice information, and its corresponding correct electronic text of “I am an Olympic champion” may be obtained by means of manual annotation or voice recognition. In this way, the voice information and electronic text may be taken as a pair of corpus samples.

In addition, the generating apparatus 02 may be provided in a clinic of each department in the hospital. However, the database 02 may also be integrated in the generating apparatus 01 as a functional unit of the generating apparatus 01. The present disclosure is not limited thereto.

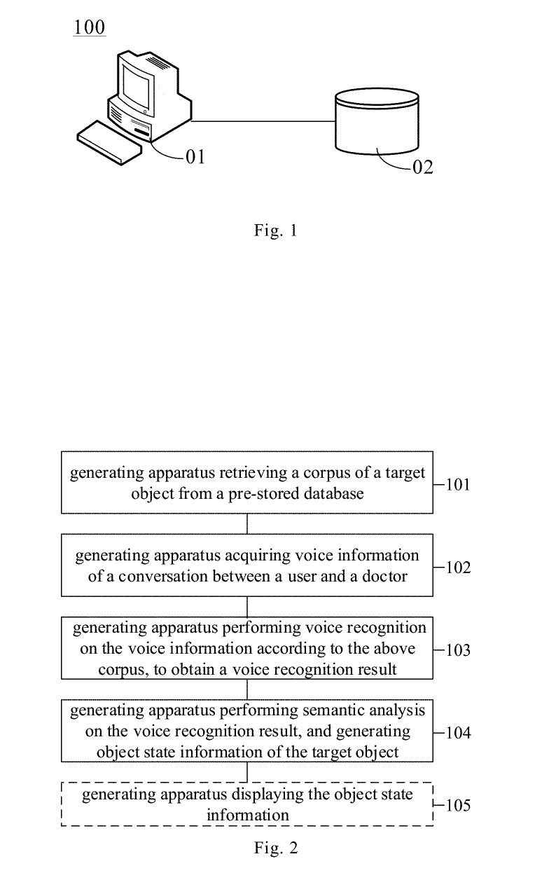

Based on the above-mentioned system 100 for generating an electronic medical record, an embodiment of the present disclosure provides a method of generating electronic medical record information, as shown in FIG. 2, the method includes following steps.

In step 101, the generating apparatus retrieves a corpus of a target object from a pre-stored database.

Because departments in the hospital are generally divided according to different diseased organs, for example, a heart disease department, a nephrology department and a cervical spondylosis department, etc., a pre-stored database may also set different corpora according to different diseased organs, for example, a corpus for the heart, a corpus for the kidney, and so on. Each corpus stores a corpus sample for a corresponding object. Contents of these corpus samples may include for example pathological data, symptom description, or prescription, etc. The embodiment of the present disclosure does not impose any limitation on this.

In the embodiment, the above object may be any diseased part, such as a diseased organ, blood or bone, or the like. The present disclosure does not impose any limitation on this. For convenience of description, for example, the subsequent embodiments will take a target organ as the target object to make illustration below.

Specifically, in step 101, when the user enters a clinic of a department, a diseased organ corresponding to the department is a target organ (i.e., a target object), and the generating apparatus may retrieve a corpus of the target organ from the above database, for subsequent voice recognition based on the corpus.

In the embodiment, the above-mentioned database may be stored in the local server of the hospital, or may also be stored in the generating apparatus itself, or may also be stored in a cloud server, and the present disclosure does not impose any limitation on this.

In step 102, the generating apparatus acquires voice information of a conversation between a user and a doctor.

For example, the voice information may include real-time voice information of the conversation between a user and a doctor; and for example, the voice information may include recorded voice information of the conversation between a user and a doctor.

For example, when the voice information includes real-time voice information of the conversation between a user and a doctor, after the user enters the clinic and talks with the doctor, i.e., after the consultation is performed, the generating apparatus may obtain the voice information of the conversation between the user and the doctor through a microphone during the process. For example, the generating apparatus may periodically obtain the voice information of the conversation between the user and the doctored every 20 seconds.

In step 103, the generating apparatus performs voice recognition on the voice information according to the above corpus, to obtain a voice recognition result.

In step 103, the generating apparatus performs voice recognition on the voice information obtained in step 102 according to the corpus retrieved in step 101, to obtain a voice recognition result.

For example, the generating apparatus may utilize an existing voice recognition software to preliminarily perform voice information on the above voice information, to obtain a preliminary recognition result. Due to the strong professionalism of the medical field, the obtained preliminary recognition result may not be accurate. For example, when the user says the voice information of “I have coronary heart disease”, the preliminary recognition results may not be able to determine what the user said is “I have coronary heart disease” or “I have coronary hard disease” which have almost the same pronunciation. At this time, two preliminary recognition results are obtained. In order to accurately recognize the above-mentioned voice information, the generating apparatus may search a target corpus sample matching the voice information from the corpus. For example, the searched corpus sample having the highest similarity to the voice information will be taken as a target corpus sample. Then, the generating apparatus may correct the above preliminary recognition result according to the target corpus sample, and obtain a more accurate voice recognition result.

In step 104, the generating apparatus performs semantic analysis on the voice recognition result, and generates object state information of the target object.

In the process of semantic analysis, a target object, i.e., a name of the target organ, will be searched from the natural language recognized from the voice, and then the target object state of the target organ will be extracted from the context containing the name of the target organ, and finally the organ state information (i.e., the object state information, such as, left ventricular hypertrophy in the heart, first intervertebral disc hyperplasia, and the like) of the target organ will be obtained.

In the embodiment, the object state information may be for example text information, and for example image information to reflect a state of the target object.

In step 105, the generating apparatus displays the object state information.

Finally, based on the organ state information of the target organ determined in step 104, the organ state information may be displayed to the user, for example, through a display screen of the generating apparatus. Alternatively, a projector connected to the generating apparatus displays a 3D organ image of the left ventricular hypertrophy, such that the user may intuitively learn about his/her own health condition. It may be unnecessary for the doctor to manually enter an electronic text that describes the target object state, thus simplifying the consultation process and improving the communication efficiency and consultation efficiency between the doctor and the patient.

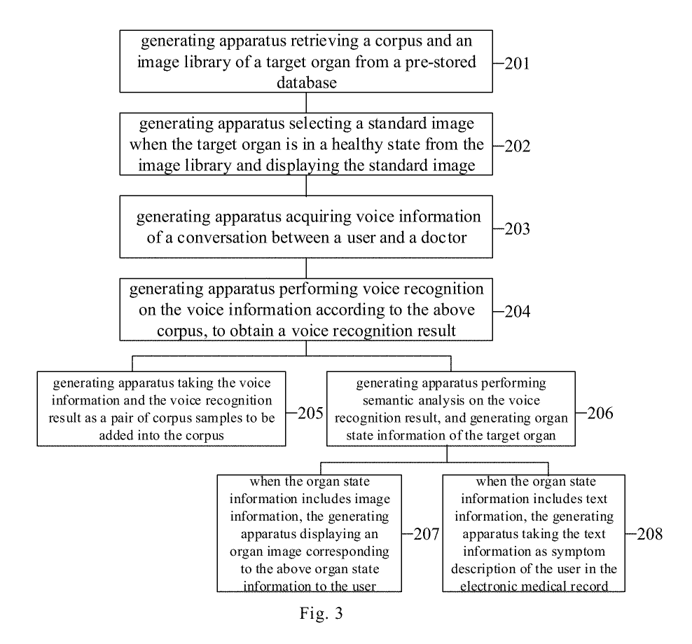

Based on the above steps 101-105, an embodiment of the present disclosure provides a method of generating electronic medical record information, as shown in FIG. 3, including following steps.

In step 201, the generating apparatus retrieves a corpus and an image library of a target organ from a pre-stored database.

Similar to step 101, when the user enters a corresponding clinic, the doctor or user may click on a corresponding function button in the generating apparatus, to trigger the generating apparatus to retrieve the corpus of the target organ from the pre-stored database. For example, if the current clinic is a heart disease clinic, the corpus of the heart may be retrieved from the database.

Different from step 101, an image library of each organ is stored in the above database. In the case of a heart, for example, a dynamic 2D/3D picture or an animation of the heart in different states may be stored. Then in step 201, the image library of the heart may also be retrieved while the corpus of the heart is retrieved.

Of course, when the corpus and the image library of the target organ are not retrieved, the human body sketch map may be displayed in the generating apparatus. When the doctor or user clicks on the corresponding diseased organ in the human body sketch map, the diseased organ may be taken as the target organ and the corpus and image library of the target organ may be retrieved.

In step 202, the generating apparatus selects a standard image when the target organ is in a healthy state from the image library and displays the standard image.

For example, the generating apparatus may select a rhythmic animation of the heart in the healthy state from the above image library and display it as the standard image, such that the user may understand the mechanism of the heart rhythm simply and intuitively.

In step 203, the generating apparatus acquires voice information of a conversation between a user and a doctor.

In the embodiment, step 203 is similar to above step 102, and therefore, it will not repeated herein.

In step 204, the generating apparatus performs voice recognition on the voice information according to the above corpus, to obtain a voice recognition result.

Similarly to above step 103, after the voice information is obtained, the generating apparatus performs voice recognition on the voice information according to the above corpus, to obtain a voice recognition result.

It should be noted that, in the process of voice recognition, it is also possible to manually modify the obtained preliminary recognition result or the corrected voice recognition result. For example, when no corpus sample matching the voice information exists in the corpus, the preliminary recognition result may be corrected by the doctor manually, and the recognition result finally confirmed by the doctor will be used as the voice recognition result.

Further, after performing step 204, following steps 205 or 206-208 may be performed simultaneously or respectively, and the embodiment of the present disclosure is not limited thereto.

In step 205, the generating apparatus takes the voice information and the voice recognition result as a pair of corpus samples to be added into the corpus.

In step 205, since the above voice recognition result has been confirmed by the doctor, that is, the voice recognition result is the correct electronic text corresponding to the above voice information, the voice information and the voice recognition result may be taken as a pair of corpus samples to be added into the corpus obtained in step 201. That is, the annotation of the corpus is achieved in the process of consultation.

Then, if voice information similar to or the same as the above voice information occurs during subsequent consultation processes, voice recognition may be performed with reference to the corpus sample stored in step 205.

Of course, a corresponding artificial intelligence program may also be set in the generating apparatus, such that the generating apparatus conducts intelligent learning according to various corpus libraries in the database, to continuously improve the accuracy of voice recognition.

In step 206, the generating apparatus performs semantic analysis on the voice recognition result, and generates organ state information of the target organ.

Similar to above step 104, the generating apparatus may perform semantic analysis on the voice recognition result after step 204, to determine the target object state of the target organ.

In addition, after performing step 206, the generating apparatus may perform following step 207 or 208 respectively or simultaneously, and the present disclosure is not limited thereto.

In step 207, when the organ state information includes image information, the generating apparatus displays an organ image corresponding to the above organ state information to the user.

In step 207, when the image library retrieved in step 201 contains the organ image corresponding to the above organ state information, the generating apparatus may select the organ image corresponding to the organ state information from the image library and replace the standard image of the target organ in the healthy state displayed in step 202. Of course, it is also possible to generate a target object state comparison diagram of the above standard image and the organ image corresponding to the organ state information, such that the user may view the change of the target organ more intuitively.

Alternatively, an algorithm for image modification may also be preset in the generating apparatus. In this way, after the target object state of the target organ is determined, the standard image displayed in step 202 may be directly corrected based on the above algorithm, to obtain an organ image corresponding to the above target object state. Similarly, it is also possible to generate a target object sate comparison diagram of the above standard image and the corrected organ image according to the algorithm.

In step 208, when the organ state information includes text information, the generating apparatus takes the text information as symptom description of the user in the electronic medical record.

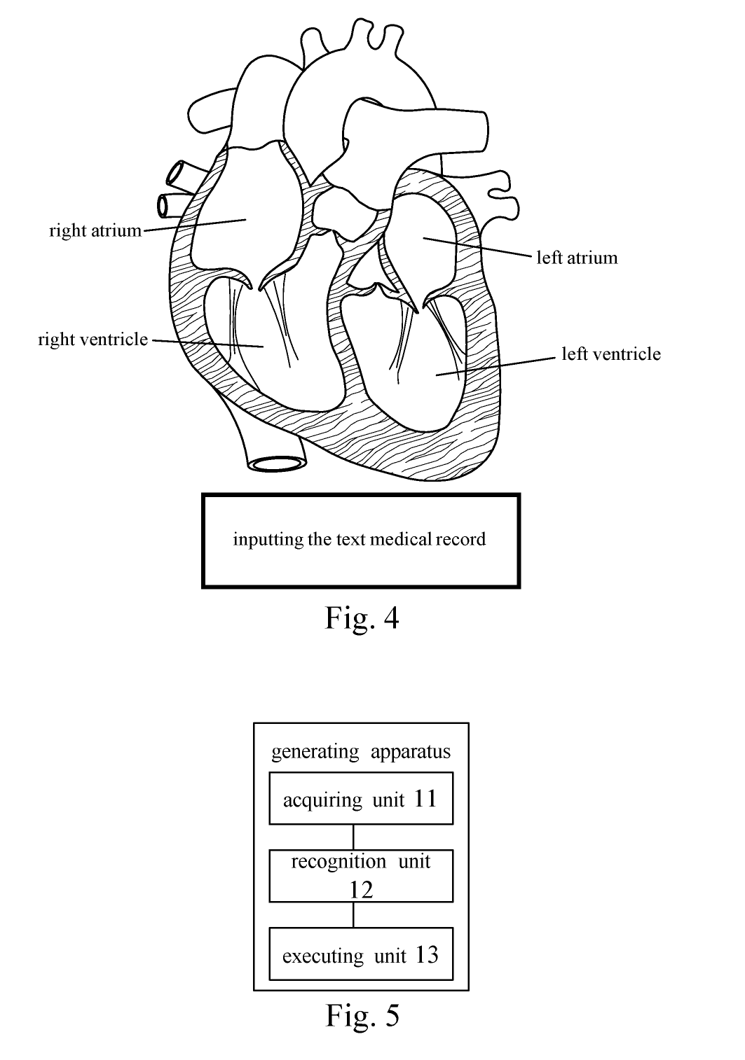

Exemplarily, a user interface of the generating apparatus may be shown in FIG. 4. In the embodiment, the display interface displays an organ image corresponding to the above organ state information. For example, the target object state of the target organ of the user is left ventricular hypertrophy, and then an organ image corresponding to the left ventricular hypertrophy may be displayed at a corresponding position within the above user interface.

In addition, a template of the electronic medical record is also provided in the user interface of the generating apparatus. Unlike that the doctor is required to manually input a content of the medical record in the prior art, the generating apparatus may use the text information in the organ state information determined in step 206 as the symptom description of the user and write it in the template of the electronic medical record. For example, the symptom description of “left ventricular hypertrophy” is generated in a text input box of the electronic medical record, which may reduce work burden of the doctor and improve the consultation efficiency.

In addition, the symptom description generated in step 208 and the organ image displayed in step 207 may be bi-directionally interacted. That is, if the text information of the symptom description in the electronic medical record is modified, for example, the doctor replenishes the content of “heart rate being too slow” in the symptom description, the generating apparatus may update the displayed organ image according to the modified symptom description, for example, it may lower the displayed rate of the heartbeat. As another example, if the displayed organ image in step 207 is modified, for example, the doctor may manually drag the right ventricle to enlarge it, the generating apparatus may update the text information in the symptom description in step 208 based on the modified organ image, for example, it may add the text of “right ventricular hypertrophy” in the symptom description.

Thus, in the method of generating electronic medical record information provided by the embodiment of the present disclosure, a corpus of a target object may be retrieved from a pre-stored database; voice information of a conversation between a user and a doctor may be acquired when they are talking with natural language or recording; voice recognition is performed on the acquired voice information according to the corpus, to obtain a voice recognition result; semantic analysis is performed on the voice recognition result, to determine a target object state of the target object, thus generating object state information of the target object in an electronic medical record. It may be seen that in the above method, in the process of consultation, by acquiring the voice information of the conversation between the user and the doctor, the target object state information of the diseased target object may be analyzed for the user, and the doctor does not need to manually enter the corresponding symptom description (for example, the target object state) for the user, thus simplifying the consultation process and improving the consultation efficiency.

FIG. 5 is a structural schematic diagram of a generating apparatus provided by an embodiment of the present disclosure. The apparatus for generating an electronic medical record provided by the embodiment of the present disclosure may be configured to embody the methods implemented by respective embodiments of the present disclosure as shown in FIGS. 2-4 above. For sake of convenience of illustration, only portions relating to the embodiment of the present disclosure are shown, and the specific technical details which are not disclosed may refer to the embodiments of the present disclosure as shown in FIGS. 2-4.

Specifically, as shown in FIG. 5, the generating apparatus includes:

an acquiring unit 11, configured to retrieve a corpus of a target object from a pre-stored database; acquire voice information of a conversation between a user and a doctor, the voice information including real-time voice information and/or recorded voice information;

an recognition unit 12, configured to perform voice recognition on the voice information according to the corpus, to obtain a voice recognition result; and

an executing unit 13, configured to perform semantic analysis on the voice recognition result, and generate object state information of the target object in an electronic medical record.

Further, the executing unit is further configured to display the object state information to the user.

Further, when the object state information includes the image information, the acquiring unit 11 is further configured to retrieve an image library of the target object from the database; and the executing unit 13 is further configured to select a standard image when the target object is in a healthy state from the image library and display the standard image.

Further, the executing unit 13 is configured to: select an organ image corresponding to the target object state from the image library, to update the standard image or generate a target object comparison diagram; or correct the standard image based on the target object state, to obtain a target object image corresponding to the target object state or a target object comparison diagram.

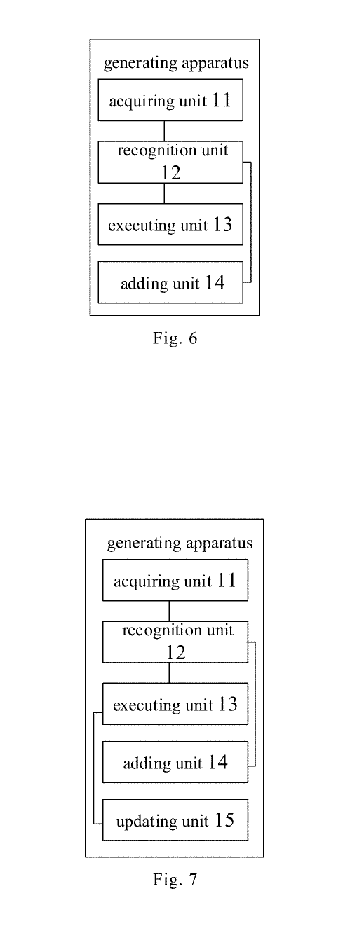

Further, as shown in FIG. 6, the apparatus further includes:

an adding unit 14, configured to take the voice information and the voice recognition result as a pair of corpus samples to be added into the corpus.

Further, the recognition unit 12 is configured to: perform voice recognition on the voice information to obtain a preliminary recognition result; search a target corpus sample matching the voice information from the corpus; and correct the preliminary recognition result according to the target corpus sample, to obtain the voice recognition result.

Further, as shown in FIG. 7, when the object state information includes the image information and the text information, the apparatus further includes:

an updating unit 15, configured to: when a symptom description is modified, update an organ image according to the modified symptom description; and when the organ image is modified, update the symptom description according to the modified organ image.

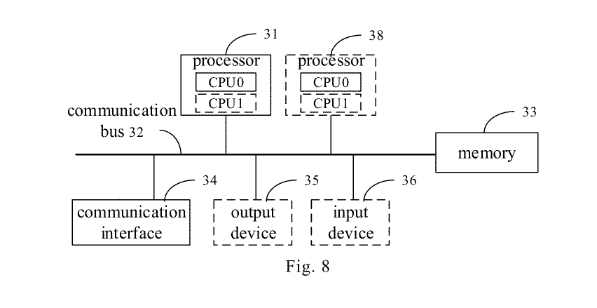

Exemplarily, the apparatuses for generating an electronic medical record as shown in FIGS. 2 to 7 may be implemented in the form of a computer device (or system) in FIG. 8.

FIG. 8 is a schematic diagram of a computer device provided by an embodiment of the present disclosure. The computer device includes at least one processor 31, a communication bus 32, a memory 33, and at least one communication interface 34.

In the embodiment, the processor 31 may be a general purpose central processing unit (CPU), a microprocessor (MCU), an application-specific integrated circuit (ASIC), field programmable gate array (FPGA) or one or more integrated circuits for controlling the execution of the program in the technical sachems of the present disclosure.

The communication bus 32 may include a path to transfer information among the above components. The communication interface 34 uses any device, such as a receiver, to communicate with other devices or communication networks, such as Ethernet, a radio access network (RAN), a wireless local area network (WLAN), or the like.

The memory 33 may be a read-only memory (ROM), other types of static storage devices which may store static information and instructions, a random access memory (RAM), other types of dynamic storage devices which may store information and instructions, an electrically erasable programmable read-only memory (EEPROM), a compact disc read-only memory (CD-ROM), other optical disk storage, optical disc storage (including compact discs, laser discs, optical discs, digital versatile discs, Blu-ray discs, etc.), magnetic disk storage media, other magnetic storage devices, or any other media which may be used to carry or store desired program codes in the form of instructions or data structures and may be accessed by a computer, but not limited thereto. The memory may exist independently and be connected to the processor via the communication bus. The memory may also be integrated with the processor.

In the embodiment, the memory 33 is configured to store application codes that execute the technical schemes of the present disclosure and the execution is controlled by the processor 31. The processor 31 is configured to execute the application codes stored in the memory 33.

In particular implementation, as an embodiment, the processor 31 may include one or more CPUs, such as CPU0 and CPU1 in FIG. 8.

In particular implementation, as an embodiment, the computer device may include a plurality of processors, such as the processor 31 and the processor 38 in FIG. 8. Each of these processors may be a single-CPU processor or a multi-CPU processor. The processor herein may refer to one or more devices, circuits, and/or processing cores for processing data (such as computer program instructions).

In a particular implementation, as an embodiment, the computer apparatus may also include an output device 35 and an input device 36. The output device 35 communicates with the processor 31 and displays the information in a variety of ways. For example, the output device 35 may be a liquid crystal display (LCD), a light emitting diode (LED) display device, a cathode ray tube (CRT) display device, or a projector, or the like. The input device 36 communicates with the processor 31 and receives input from the user in a variety of ways. For example, the input device 36 may be a mouse, a keyboard, a touch screen device, a sensing device, or the like.

The above-mentioned computer device may be a general purpose computer device or a dedicated computer device. In particular implementation, the computer device may be a desktop computer, a portable computer, a web server, a personal digital assistant (PDA), a mobile phone, a tablet, a wireless terminal device, a communication device, an embedded device, or a device having a structure similar to that in FIG. 8. The embodiment of the present disclosure does not limit the type of computer device.

Thus, in the apparatus of generating an electronic medical record provided by the embodiment of the present disclosure, a corpus of a target object may be retrieved from a pre-stored database; voice information of a conversation between a user and a doctor may be acquired when they are talking with natural language or recording; voice recognition is performed on the acquired voice information according to the corpus, to obtain a voice recognition result; semantic analysis is performed on the voice recognition result, to determine a target object state of the target object, thus generating object state information of the target object in an electronic medical record. It may be seen that in the above method, in the process of consultation, by acquiring the voice information of the conversation between the user and the doctor, the target object state information of the diseased target object may be analyzed for the user, and the doctor does not need to manually enter the corresponding symptom description (for example, the target object state) for the user, thus simplifying the consultation process and improving the consultation efficiency.

In the description of the specification, specific features, structures, materials, or features may be combined in any suitable embodiment or example in any suitable manner.

Only specific embodiments of the present disclosure are described above. However, the protection scope of the present disclosure is not limited thereto. Any person skilled in the art will be able to easily think of variations or substitutions within the technical scope disclosed in the present disclosure, which is intended to be within the protection scope of the present disclosure. Accordingly, the protection scope of the present disclosure is subject to the protection scope of the claims.

What is claimed is:

1. A method of generating electronic medical record information, comprising:
retrieving a corpus of a target object from a pre-stored database;
acquiring voice information of a conversation during a consultation of a user, the voice information comprising at least one of real-time voice information and recorded voice information;
performing voice recognition on the voice information according to the corpus, to obtain a voice recognition result; and
performing semantic analysis on the voice recognition result, and generating object state information of the target object in an electronic medical record.

2. The method of claim 1, wherein the object state information comprises: at least one of text information and image information reflecting a target object state.

3. The method according to claim 1, wherein after the steps of performing semantic analysis on the voice recognition result and generating object state information of the target object, the method further comprises:
displaying the object state information to the user.

4. The method according to claim 3, wherein the object state information comprises the image information, before the step of generating object state information of the target object, the method further comprises:
retrieving an image library of the target object from the database; and
selecting a standard image corresponding to the target object in a healthy state from the image library and displaying the standard image.

5. The method according to claim 4, wherein the step of displaying the object state information to the user comprises:
selecting an organ image corresponding to the target object state from the image library, to perform at least one of the following two operations: updating the standard image and generating a target object comparison diagram.

6. The method according to claim 4, wherein the step of displaying the object state information to the user comprises:
correcting the standard image based on the target object state, to obtain at least one of a target object image corresponding to the target object state and a target object comparison diagram.

7. The method according to claim 1, wherein after the step of performing voice recognition on the voice information according to the corpus to obtain a voice recognition result, the method further comprises:
taking the voice information and the voice recognition result as a pair of corpus samples to be added into the corpus.

8. The method according to claim 1, wherein the step of performing voice recognition on the voice information according to the corpus to obtain a voice recognition result comprises:
performing voice recognition on the voice information to obtain a preliminary recognition result;
searching a target corpus sample matching the voice information from the corpus; and
correcting the preliminary recognition result according to the target corpus sample, to obtain the voice recognition result.

9. The method according to claim 2, wherein the object state information comprises the image information and the text information, the method further comprises:
in the case where the text information is modified, updating the image information based on the modified text information; and
in the case where the image information is modified, updating the text information based on the modified image information.

10. An apparatus for generating an electronic medical record, comprising:
a processor; and
a memory, configured to store instructions executable by the processor,
wherein the processor is configured to:
retrieve a corpus of a target object;
acquire voice information of a conversation during a consultation of a user, the voice information comprising at least one of real-time voice information and recorded voice information;
perform voice recognition on the voice information according to the corpus, to obtain a voice recognition result; and
perform semantic analysis on the voice recognition result, and generating object state information of the target object in an electronic medical record.

11. The apparatus according to claim 10, wherein the processor is further configured to display the object state information to the user.

12. The apparatus of claim 10, wherein the object state information comprises the image information, the processor is further configured to:
retrieve an image library of the target object; and
select a standard image when the target object is in a healthy state from the image library and display the standard image.

13. The apparatus of claim 12, wherein the processor is further configured to:
select an organ image corresponding to the target object state from the image library, to perform at least one of the following two operations: updating the standard image and generating a target object comparison diagram.

14. The apparatus of claim 12, wherein the processor is further configured to:
correct the standard image based on the target object state, to obtain at least one of a target object image corresponding to the target object state and a target object comparison diagram.

15. The apparatus of claim 10, wherein the processor is further configured to:
take the voice information and the voice recognition result as a pair of corpus samples to be added into the corpus.

16. The apparatus of claim 10, wherein the processor is further configured to:
perform voice recognition on the voice information to obtain a preliminary recognition result;
search a target corpus sample matching the voice information from the corpus; and
correct the preliminary recognition result according to the target corpus sample, to obtain the voice recognition result.

17. The apparatus of claim 10, wherein the object state information comprises the image information and the text information, the processor is further configured to:
in the case where a symptom description is modified, update an organ image according to the modified symptom description; and
in the case where the organ image is modified, update the symptom description according to the modified organ image.

18. A system of generating electronic medical record information, comprising: the apparatus for generating an electronic medical record according to claim 10; and a database that is in data connection to the apparatus for generating an electronic medical record, the database storing at least one of the corpus and an image library of the target object.
